(19) United States
(12) Patent Application Publication
(10) Pub. No.: US 2024/0312338 A1
(43) Pub. Date: Sep. 19, 2024

(54) DEVICE AND METHOD FOR SELECTIVELY ENABLING EXECUTION OF VIDEO ANALYTICS ON VIDEOS CAPTURED BY CAMERAS

(71) Applicant: MOTOROLA SOLUTIONS, INC., CHICAGO, IL (US)

(72) Inventors: ROBERT MROWIEC, LISZKI (PL); LEE M. PROCTOR, CARY, IL (US)

(21) Appl. No.: 18/184,025

(22) Filed: Mar. 15, 2023

(51) Int. Cl. G08B 31/00; G06V 20/40; G06V 20/52

(52) U.S. Cl. CPC G08B 31/00; G06V 20/44; G06V 20/52; G06V 2201/07

(57) ABSTRACT

A process of selectively enabling execution of video analytics on videos captured by cameras. In operation, an electronic computing device accesses an incident database identifying incidents resolved by one or more agencies. The incidents include a first set of incidents that were first reported to the agencies by a human source and a second set of incidents that were first reported to the agencies by a video analytics system. The electronic computing device then estimates a first average cost incurred in resolving the first set of incidents and a second average cost incurred in resolving the second set of incidents. The electronic computing device enables the video analytics system to execute video analytics on videos captured by the one or more cameras to proactively detect and report incidents when the first average cost is higher than the second average cost by at least the predefined threshold.

### BACKGROUND

Security operators screen videos to monitor for abnormal or suspicious activities. Since manually screening large amounts of videos received from cameras is a tedious process for operators, security agencies have come to rely on video analytics solutions that automatically analyze video data and provide alerts to security operators when suspicious objects or events are detected.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is an example of electronic records stored in an incident database shown in FIG. 1 in accordance with some embodiments.

FIG. 3 is a block diagram of an electronic computing device shown in FIG. 1 in accordance with some embodiments.

FIG. 4 illustrates a flowchart of a process for selectively enabling execution of video analytics on videos captured by cameras in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Video analytics can help with proactively detecting public-safety incidents even before they are reported by a witness or victim. Proactive execution of video analytics may have cost savings resulting from otherwise employing human resources to search video recordings and detect an incident as well as a person of interest after the incident has already been reported by a witness or victim. However, continuous execution of video analytics tasks for proactive detection of incidents can drain computing resources as well as incur costs associated with maintaining. repairing, replacing, or upgrading the computing resources. Using cloud-based video analytics services also has an associated cost, which may vary depending on the subscription service and/or on-demand service offered by cloud-based video analytics service providers. Computing resources (e.g., processing load, data storage, network connectivity, electrical power etc.,) may dramatically vary depending on the activity levels and environmental factors associated with a scene in addition to the type of analytics to be performed on video recordings captured corresponding to the scene. The costs incurred in executing video analytics or the cost savings resulting from proactive execution of video analytics also dynamically change over time and depend on many factors. Accordingly, any automation to enable or disable execution of video analytics should be made considering the dynamic cost changes incurred in continuous execution of proactive video analytics as well as the dynamic cost savings resulting from proactive execution of video analytics. Disclosed is an improved device and process for selectively enabling execution of video analytics on videos captured by cameras.

One embodiment provides a method of selectively enabling execution of video analytics on videos captured by cameras. The method comprises: accessing, at an electronic computing device, an incident database identifying incidents resolved by one or more agencies, the incidents including a first set of incidents that were first reported to the one or more agencies by a human source and a second set of incidents that were first reported to the one or more agencies by a video analytics system that is configured to execute video analytics on videos captured by one or more cameras; estimating, at the electronic computing device, a first average cost incurred in resolving the first set of incidents; estimating, at the electronic computing device, a second average cost incurred in resolving the second set of incidents; determining, at the electronic computing device, whether the first average cost is higher than the second average cost by at least a predefined threshold; and determining, at the electronic computing device, that the video analytics system is currently disabled from executing video analytics on videos captured by the one or more cameras and responsively enabling the video analytics system to execute video analytics on videos captured by the one or more cameras to proactively detect and report incidents when the first average cost is higher than the second average cost by at least the predefined threshold.

Another embodiment provides an electronic computing device comprising a communications interface and an electronic processor communicatively coupled to the communication interface. The electronic processor is configured to: access, via the communications interface, an incident database identifying incidents resolved by one or more agencies, the incidents including a first set of incidents that were first reported to the one or more agencies by a human source and a second set of incidents that were first reported to the one or more agencies by a video analytics system that is configured to execute video analytics on videos captured by one or more cameras; estimate a first average cost incurred in resolving the first set of incidents; estimate a second average cost incurred in resolving the second set of incidents; determine whether the first average cost is higher than the second average cost by at least a predefined threshold; and determine that the video analytics system is currently disabled from executing video analytics on videos captured by the one or more cameras and responsively enable the video analytics system to execute video analytics on videos captured by the one or more cameras to proactively detect and report incidents when the first average cost is higher than the second average cost by at least the predefined threshold.

Each of the above-mentioned embodiments will be discussed in more detail below, starting with example system and device architectures of the system in which the embodiments may be practiced, followed by an illustration of processing blocks for achieving an improved technical device and method of selectively enabling execution of video analytics on video captured by cameras. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

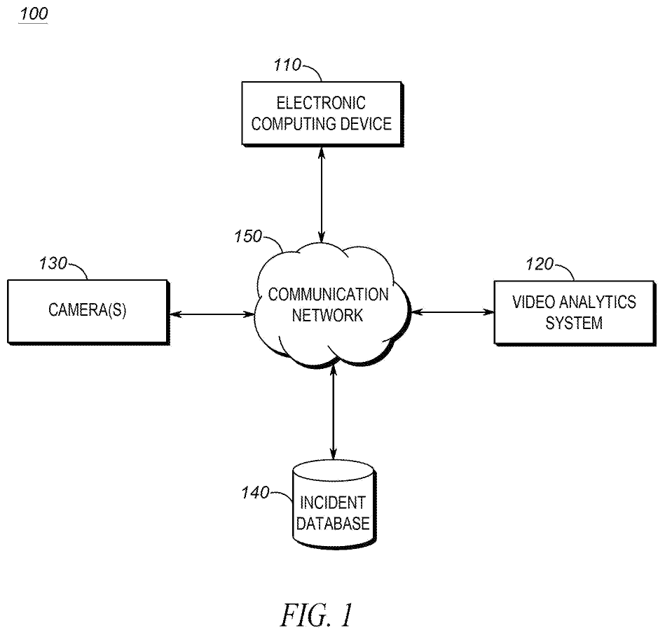

Referring now to the drawings, and in particular FIG. 1, a system 100 is shown including an electronic computing device 110, a video analytics system 120, one or more cameras 130, an incident database 140, and a communication network 150. The electronic computing device 110 is any computing device configured to selectively enable or disable execution of video analytics on videos captured by the one or more cameras 130. The electronic computing device 110 may be implemented as a standalone electronic device or alternatively integrated into the video analytics system 120 and/or the cameras 130. In accordance with some embodiments, the electronic computing device 110 may be authorized by agencies to automatically enable or disable execution of video analytics on videos captured by particular cameras 130. An agency is an organizational entity that may be responsible for resolving one or more incidents reported to the agency by a human source (e.g., a witness, a victim, or some other person reporting an incident using an emergency call service or a tip submission service) or by a machine source (e.g., video analytics system 120 reporting an incident by proactively executing video analytics on videos captured by the cameras 130). In some embodiments, an agency may represent a private enterprise organization such as press, media, utilities, oil/gas, electric, private security, or other business. In other embodiments, an agency may represent a public organization such as a public-safety agency (e.g., police, fire, emergency medical service), governmental entity (e.g., court, city administration), and the like.

The video analytics system 120 is formed of computing devices selected from one or more of edge computing devices and cloud computing devices that are configured to run video analytics on videos captured by an associated set of cameras 130. For instance, when implemented at an edge computing device, the video analytics system 120 may be housed in the same premise (e.g., same building or facility), or otherwise coupled to the same communication network (e.g., a local area network), as the camera 130. Alternatively, the video analytics system 120 may be implemented on cloud computing devices that may comprise any number of computing devices and servers, and may include any type and number of resources, including resources that facilitate communications with and between servers, storage by the servers that are hosted remotely over one or more communication networks 150. The cloud computing devices may include any resources, services, and/or functionality that can be utilized through an on-demand or subscription service for executing video analytics tasks. The edge or cloud computing devices included in the video analytics system 120 include a video analytics engine that is configured to analyze videos captured by an associated camera 130 corresponding to a scene and further detect an activity of interest (e.g., a person, object, or event) from the captured videos according to a type of video analytics task assigned for execution at the computing device. In one embodiment, the video analytics engine implemented at the video analytics system 120 is programmed with a detection classifier that evaluates a video, for example, an image or part of an image of the video captured by the camera 130 to determine if an instance of a person, object. or event of interest that is defined in the detection classifier is detected or not from the evaluated video. The video analytics system 120 then transmits results (e.g., detection of a person, object, or event of interest) of the video analytics task to a remote server for review by one or more agencies. In accordance with some embodiments, the video analytics system 120 may be owned and/or operated by an agency that also owns and/or operates the cameras 130. For example, an agency operating the camera 130 may assign certain video analytics tasks corresponding to videos captured by the camera 130 to the video analytics system 120. The video analytics task may include, for example, detecting a person (e.g., a wanted suspect), an object (e.g., a vehicle displaying a particular license plate number), an event of interest (e.g., abnormal crowd behavior, shots fired, vehicle collision, etc.,), or a combination of multiple tasks (e.g., searching for a wanted suspect in addition to running license plates of vehicles detected in a scene).

The one or more cameras 130 are configured to capture a video of a real-world scene corresponding to a field of view of the respective video cameras 130. The cameras 130 may include any number of fixed or portable video cameras that may be deployed in the system 100 in any number of locations. The cameras 130 may include, but not limited to, surveillance cameras, vehicular cameras, body worn cameras, mobile cameras, drone cameras, pocket cameras, and the like. In accordance with embodiments, the cameras 130 may be owned or operated by one or more agencies. In accordance with some embodiments, execution of video analytics may be selectively enabled or disabled for a particular set of cameras 130 during a particular period of time. In accordance with some embodiments, the electronic computing device 110 may selectively enable execution video analytics for videos captured by a first subset of cameras 130 deployed in a location even while execution of video analytics for videos captured by a second subset of cameras 130 deployed in the same location are disabled.

One or more incident databases 140 may be implemented using any type of storage device, storage server, storage area network, redundant array of independent discs, cloud storage device, or any type of local or network-accessible data storage device configured to store data records for access by computing devices. In some embodiments, the one or more incident databases 140 are implemented in commercial cloud-based storage devices. In some embodiments, the one or more incident databases 140 are housed on suitable on-premise database servers or edge computing devices that may be owned and/or operated by one or more of public-safety or private agencies. The one or more incident databases 140 may be maintained by third parties as well. In accordance with embodiments, the incident database 140 includes electronic records of reported incidents including pending incidents as well as resolved incidents. The incident database 140 stores electronic records in any suitable format or data type, for example, video, image, audio, text, or combination thereof. As an example, the electronic record stored at the incident database 140 may represent an image or a video recorded by a body-worn camera, an audio (e.g., talk group conversations) recorded by a land mobile radio, or text data (e.g., an incident report) entered by a dispatcher. In accordance with some embodiments, the electronic records stored at the incident database 140 may be associated with different agencies (e.g., police department, city administration, court etc.,). In accordance with some embodiments, the electronic computing device 110 obtains permission to access and process all or subset of electronic records maintained in one or more incident databases 140 for the purpose of selectively enabling or disabling execution of video analytics on videos captured by the cameras 130.

In accordance with embodiments, the electronic computing device 110 may, periodically or in response to a specific request from a computing device affiliated with an agency, access the incident database 140 to retrieve information corresponding to a first set of incidents that were first reported to the agency by a human source and information corresponding to a second set of incidents that were first reported to the agency by the video analytics system 120. The electronic computing device 110 then compares an average cost incurred in resolving incidents first reported by the human source with an average cost incurred in resolving incidents first reported by the video analytics system 120. Based on the comparison, the electronic computing device 110 may selectively enable or disable execution of video analytics at the video analytics system 120 corresponding to videos captured by one or more cameras 130. For example, if the average cost incurred in resolving incidents first reported by the human source is higher than the average cost incurred in resolving incidents first reported by the video analytics system by at least a predefined threshold and if the video analytics system 120 is currently disabled from executing video analytics on videos captured by the one or more cameras 130, then the electronic computing device 110 enables the video analytics system 120 to execute video analytics on video captured by the cameras 130. In some embodiments, the electronic computing device 110 may first electronically notify a computing device associated with a requesting agency with a recommendation to enable (or disable) execution of video analytics at the video analytics system 120. In these embodiments, the electronic computing device 110 proceeds to enable (or disable) execution of video analytics at the video analytics system 120 only after receiving a response from the computing device of the agency with a permission to enable (or disable) execution of video analytics at the video analytics system 120.

The electronic computing device 110, the video analytics system 120, the cameras 130, and the incident database 140 may each include one or more wired or wireless communication interfaces for communicating with other devices operating in the system 100 via the communication network 150. The communication network 150 is an electronic communications network including wired and wireless connections. The communication network 150 may be implemented using a combination of one or more networks including, but not limited to, a wide area network, for example, the internet; a local area network, for example, a Wi-Fi network, or a near-field network, for example, a Bluetooth™ network. Other types of networks, for example, a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof may also be used. As an example, the camera 130 may transmit videos captured by the camera 130 to the video analytics system 120 via a local area network to enable the video analytics system 120 to execute an assigned video analytics task. As another example, the camera 130 may transmit videos captured by the camera 130 to the video analytics system 120 via a wide area network to enable the video analytics system 120 to execute an assigned video analytics task.

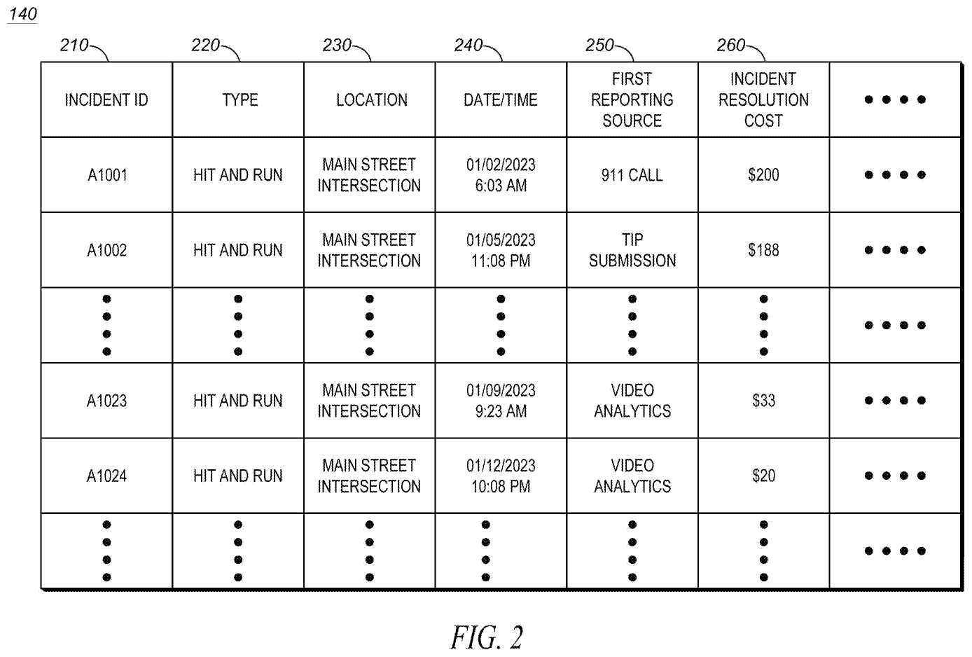

FIG. 2 is an example of electronic records stored corresponding to one or more resolved incidents (e.g., incidents in which a suspect has been identified and/or apprehended) in an incident database 140. In accordance with some embodiments, an electronic record stored corresponding to each resolved incident in the incident database 140 includes, but not limited to, an incident identifier field 210, a type field 220, a location field 230, a date/time field 240, a first reporting source field 250, and an incident resolution cost field 260. The incident identifier field 210 includes an identifier (e.g., a computer aided database identifier or a CAD identifier) uniquely identifying an incident. The type field 220 identifies a type and/or severity of an incident (e.g., a vehicle accident, a robbery, a burglary, a hit and run etc.,). The location field 230 includes information regarding a location in which the incident occurred. The location may be identified, for example, as a street or building address, a landmark, or location coordinates. The date/time field 240 includes information identifying a date and/or time during which the incident occurred. The first reporting source field 250 identifies a source which first reported the incident to an agency responsible for handling the incident. In accordance with some embodiments, the source may be a human source (e.g., a victim, a witness, a first responder, or any other person) or a machine source (e.g., a video analytics system 120). Additionally, the first reporting source field 250 may also identify a service (e.g., 911 call service or tip submission service) through which the incident was first reported by a human source. It should be noted that in some cases, it is possible that a particular incident may be reported by multiple sources, i.e., by a human source as well as the video analytics system 120. In such cases, the first reporting source field 250 corresponding to an incident identifies a first reporting source as the video analytics system 120 if the particular incident was reported by the video analytics system 120 (e.g., to a public-safety agency that is responsible for responding to a detected type of incident) prior to the reporting of the same incident by a human source. Alternatively, the first reporting source field 250 corresponding to an incident identifies a first reporting source as the human source if the particular incident was reported by the human source prior to the reporting of the same incident by the video analytics system 120.

The incident resolution cost field 260 identifies a cost incurred in resolving an incident. As an example, the cost for resolving an incident that is first reported by a human source may be computed based on one or more of: a human resource cost for time spent in manually searching videos (e.g., to identify a person of interest) captured from the cameras 130 after the incident has been reported by the human source, a cloud and/or edge computing cost associated with post-incident execution of video analytics at the video analytics system 120 to automatically process videos (e.g., to identify a person of interest) captured from the cameras 130 in response to reporting of the incident by a human source, and a human resource cost for time spent in resolving an incident (e.g., searching and apprehending a person of interest identified through manual searching of videos or automated processing of videos by the video analytics system 120 or based on information reported by human source) reported by the human source. Similarly, the cost for resolving an incident first reported by the video analytics system 120 may be computed based on one or more of: a cloud and/or edge computing cost (e.g., cost of using computing resources such as processor, memory, power, bandwidth, cloud service subscription cost, or on-demand service cost etc.,) associated with proactively executing video analytics at the video analytics system 120, a human resource cost for time spent in validating or verifying an incident first reported by the video analytics system 120, a human resource cost for time spent in resolving an incident (e.g., searching and apprehending a person of interest identified through automated processing of videos by the video analytics system 120) first reported by the video analytics system 120. In one embodiment, the incident resolution cost field 260 also includes information related to factors that contribute to the cost incurred in resolving a corresponding incident. The factors may include, for example, the amount of central processing unit (CPU), graphical processing unit (GPU), memory, power, or other computing or human resources used for resolving an incident. In accordance with embodiments, the cost of resolving an incident varies according to the number of cameras 130, locations where cameras 130 are deployed, video resolution, type of video analytics tasks, time duration between reporting of the incident and resolving the incident, and number of human resources employed for reporting an incident or validating an incident first reported by the video analytics system 120. In accordance with some embodiments, the electronic computing device 110 differentiates same or similar type of incidents (or incidents reported to have occurred in same or similar locations) according to whether the incidents were first reported by a human source or the video analytics system 120 and further selectively enables or disables execution of video analytics based on variations in costs incurred in resolving incidents reported through human sources and video analytics systems.

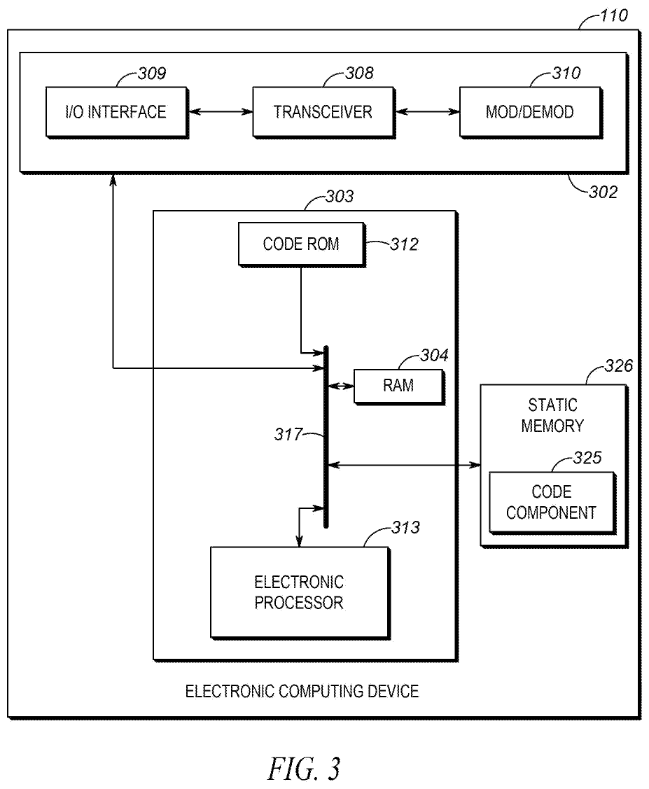

FIG. 3 is an example functional block diagram of an electronic computing device 110 operating within the system 100 in accordance with some embodiments. The electronic computing device 110 performs the functions of the electronic computing device 110 shown in FIG. 1 and may be embodied in computing devices not illustrated in FIG. 1, and/or may be a distributed computing device across two or more of the foregoing (or multiple of a same type of one of the foregoing) and linked via a wired and/or wireless communication link(s). In one embodiment, one or more functions of the electronic computing device 110 may be executed at one or more of the video analytics system 120 and/or the cameras 130. While FIG. 2 represents an electronic computing device 110 described above with respect to FIG. 1, depending on the type of electronic computing device 110, the electronic computing device 110 may include fewer or additional components in configurations different from that illustrated in FIG. 3.

As shown in FIG. 3, the electronic computing device 110 includes a communications interface 302 coupled to a common data and address bus 217 of a processing unit 303. The communications interface 302 sends and receives data to and from other devices (e.g., video analytic system 120, cameras 130, incident database 140 etc.,) in the system 100. The communications interface 302 may include one or more wired and/or wireless input/output (I/O) interfaces 309 that are configurable to communicate with other devices in the system 100. For example, the communications interface 302 may include one or more wireless transceivers 308, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications interface 302 may additionally or alternatively include one or more wireline transceivers 308, such as an Ethernet transceiver, a USB transceiver, or similar transceiver configurable to communicate via a twisted pair wire, a coaxial cable, a fiber-optic link, or a similar physical connection to a wireline network. The transceiver 308 is also coupled to a combined modulator/demodulator 310.

The processing unit 303 may include an encoder/decoder with a code Read Only Memory (ROM) 312 coupled to the common data and address bus 317 for storing data for initializing system components. The processing unit 303 may further include an electronic processor 313 (for example, a microprocessor, a logic circuit, an application-specific integrated circuit, a field-programmable gate array, or another electronic device) coupled, by the common data and address bus 317, to a Random Access Memory (RAM) 304 and a static memory 326. The electronic processor 313 may generate electrical signals and may communicate signals through the communications interface 302, such as for receipt by the video analytics system 120 and the camera 130. The electronic processor 313 has ports for coupling to the other components within the electronic computing device 110.

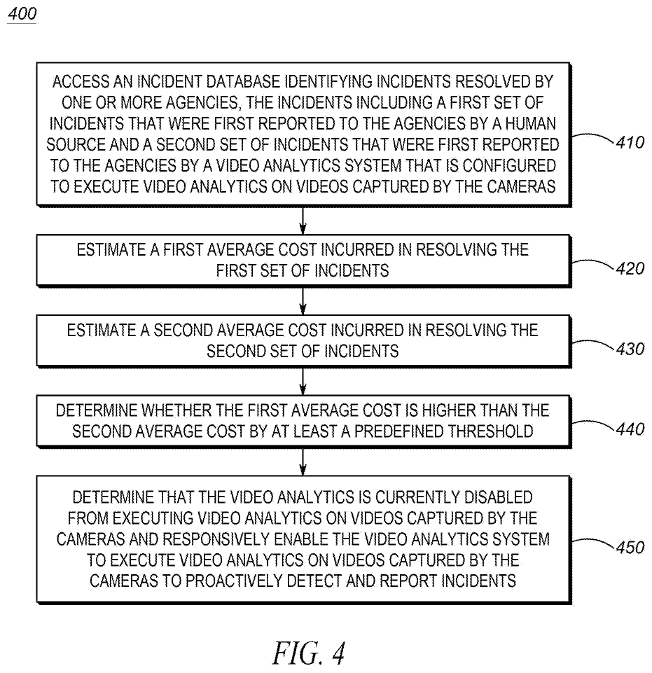

Static memory 326 may store operating code 325 for the electronic processor 313 that, when executed, performs one or more of the blocks set forth in FIG. 4 and the accompanying text(s). The static memory 326 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 326 may further temporarily or permanently store information (e.g., electronic records retrieved from the incident database 140) that may be used by the electronic computing device 110 to selectively enable or disable execution of video analytics on videos captured by the cameras 130.

Turning now to FIG. 4, a flowchart diagram illustrates a process 400 of selectively enabling execution of video analytics on videos captured by cameras 130. While a particular order of processing steps, message receptions, and/or message transmissions is indicated in FIG. 4 as an example, timing and ordering of such steps, receptions, and transmissions may vary where appropriate without negating the purpose and advantages of the examples set forth in detail throughout the remainder of this disclosure. An electronic computing device 110 shown in FIG. 1 and/or FIG. 3, and embodied as a singular computing device or distributed computing device may execute process 400 via an electronic processor 313 implemented at the electronic computing device 110.

The electronic computing device 110 may execute the process 400 at power-on, at some predetermined periodic time period thereafter, in response to a trigger raised locally at the electronic computing device 110 via an internal process or via an input interface (e.g., input interface 309) or in response to a trigger from an external device to which the electronic computing device 110 is communicably coupled, among other possibilities. As an example, the electronic computing device 110 is programmed to trigger execution of the process 400 in response to receiving a request from a computing device associated with one or more agencies. The request may include information identifying one or more cameras 130 corresponding to which the agency is requesting the electronic computing device 110 to selectively enable or disable execution of video analytics. The request may also include a link to electronic records of incidents (e.g., same or similar type of incidents resolved by a particular requesting agency, incidents reported to have occurred during a same time period or within a same geographical area) stored in the incident database 140 and associated information relating to whether each incident was first reported by a human source or a video analytics system 120 as well as the cost or factors contributing to the cost of resolving the respective incidents.

At block 410, the electronic computing device 110 accesses the incident database 140 containing electronic records of incidents resolved by one or more agencies. In accordance with embodiments, the incident database 140 includes a first set of incidents that were first reported to the one or more agencies (e.g., via an emergency call service or a tip submission service) by a human source (e.g., a victim or a witness) and a second set of incidents that were first reported to the one or more agencies by the video analytics system 120. In one embodiment, the electronic computing device 110 selects the first set of incidents and the second set of incidents based on inputs received in a request received from the one or more agencies for the purpose of determining whether to enable or disable execution of video analytics at the video analytics system 120. In another embodiment, the electronic computing device 110 automatically selects a sample of incidents to be analyzed for the purpose of determining whether to enable or disable execution of video analytics at the video analytics system 120. The electronic computing device 110 may select incidents resolved by one or more agencies based on one or more factors including, but not limited to, incident type, incident location, incident date/time, incident jurisdiction, number of incidents reported during a given time period by a human source or a video analytics system, and number of deployed cameras 130. In one embodiment, the electronic computing device 110 selects a sample of incidents to be included in the first set of incidents and the second set of incidents such that each incident included in the first set of incidents and the second set of incidents is associated with one or more of (i) a same or similar incident type (e.g., hit and run incident), (ii) a same geographical area or a geographical area with similar demography (e.g., main street intersection), (iii) a jurisdiction controlled by the same agency (e.g., police department), and (iv) a same or similar timeframe determined based on time, date, day, or season during which the incidents were reported to have occurred. The above mentioned factors are intended only to be examples and other factors not listed here can also be used to select incidents to be included in the first set of incidents and the second set of incidents. As an example, the electronic computing device 110 may select incidents such that the first set of incidents occurred in a jurisdiction controlled by a first agency and the second set of incidents that are of a same or similar type to the first set of incidents, where the second set of incidents occurred in a jurisdiction controlled by a second agency different from the first agency.

In accordance with embodiments, during or after selecting a sample of incidents to be considered for the purpose of enabling or disabling execution of video analytics at the video analytics system 120, the electronic computing device 110 retrieves an electronic record stored corresponding to each incident in the incident database 140 to determine whether the incident was first reported by a human source or the video analytics system 120. More particularly, the electronic computing device 110 determines, from the first reporting source field 250 of the electronic record stored corresponding to each incident to determine that the incident was either first reported by a human source or the video analytics system 120. If it is determined that the incident was first reported by the human source, the electronic computing device 110 includes the incident in the category of the first set of incidents, where each incident included in the first set of incidents was reported by the human source. Alternatively, if it is determined that the incident was first reported by the video analytics system 120, the electronic computing device 110 includes the incident in the category of the second set of incidents, where each incident included in the second set of incidents was reported by the video analytics system 120.

Next at block 420, the electronic computing device 110 estimates a first average cost incurred in resolving the first set of incidents that were first reported to the one or more agencies by a human source. In one embodiment, the electronic computing device 110 retrieves, from the incident resolution cost field 260 of the electronic record stored corresponding to each incident included in the first set of incidents, an incident resolution cost for resolving the incident. The electronic computing device 110 then determines the first average cost by averaging (or using another suitable function) the incident resolution costs retrieved corresponding to all the incidents included in the first set of incidents. In another embodiment, the electronic computing device 110 may compute the first average cost as a function of one or more of: human resource cost for time spent in manually searching videos captured from the cameras 130 for each incident in the first set of incidents after the incident has been reported by the human source, cloud and/or edge computing device cost associated with executing video analytics at the video analytics system 120 for each incident in the first set of incidents after the incident has been first reported by the human source, and human resource cost for time spent in resolving each incident in the first set of incidents reported by the human source.

Next at block 430, the electronic computing device 110 estimates a second average cost incurred in resolving the second set of incidents that were first reported to the one or more agencies by the video analytics system 120. In one embodiment, the electronic computing device 110 retrieves, from the incident resolution cost field 260 of the electronic record stored corresponding to each incident included in the second set of incidents, an incident resolution cost for resolving the incident. The electronic computing device 110 then determines the second average cost by averaging (or using another suitable mathematical function) the incident resolution costs retrieved corresponding to all the incidents included in the second set of incidents. In another embodiment, the electronic computing device 110 may compute the second average cost as a function of one or more of: cloud and/or edge computing cost associated with executing video analytics at the video analytics system 120 for each incident in the second set of incidents prior to the incident being first reported by the video analytics system, human resource cost for time spent in validating each incident in the second set of incidents reported by the video analytics system 120, and human resource cost for time spent in resolving each incident in the second set of incidents reported by the video analytics system 120.

At block 440, the electronic computing device 110 determines whether the first average cost incurred in resolving incidents reported by the human source is higher than the second average cost incurred in resolving incidents reported by the video analytics system 120 by at least a predefined threshold. The predefined threshold is a cost threshold that is determined either based on a user input or based on historical data. As an example, an agency may determine that any cost difference greater than $200 would provide business justification to enable or disable execution of video analytics on videos captured by a particular set of cameras 130. In this example, the agency may set the predefined threshold as $200. In one embodiment, the predefined threshold may be adjusted as a function of one or more of: criticality of the first set of incidents and second set of incidents, date and time of occurrence of the first set of incidents and the second set of incidents, number of incidents in the first set of incidents and the second set of incidents, one or more regions in which the first set of incidents and the second set of incidents occurred. In one embodiment, the electronic computing device 110 deducts average revenues (e.g., parking fines) respectively collected in relation with resolving the first set of incidents from the first average cost prior to determining whether the first average cost is higher than the second average by at least a predefined threshold.

At block 450, if the electronic computing device 110 determines that the first average cost incurred in resolving incidents reported by the human source is higher than the second average cost incurred in resolving incidents reported by the video analytics system 120 by at least the predefined threshold, the electronic computing device 110 further determines whether the video analytics system 120 is currently disabled from executing video analytics on videos captured by the cameras 130 (e.g., an identified set of cameras deployed in locations where the incidents included in the first and second set of incidents were reported to have occurred). If the video analytics system 120 is currently disabled from executing video analytics on videos captured by the cameras 130, then the electronic computing device 110 enables the video analytics system 120 to execute video analytics on videos captured by the cameras 130 to proactively detect and report incidents, i.e., without relying on a human source to detect and report incidents. In one embodiment, the electronic computing device 110 transmits a notification to a computing device of a requesting agency (i.e., an agency requesting the electronic computing device 110 to selectively enable or disable execution of video analytics for an identified set of cameras) with a recommendation that the video analytics be enabled for videos captured from an identified set of cameras 130 operated or owned by the agencies. The notification may also include information relating to incidents that have been sampled from the incident database 140 for determining that an average cost incurred in resolving incidents first reported by the human source is higher than an average cost incurred in resolving incidents first reported by the video analytics system 120 by at least the predefined threshold. In this embodiment, the electronic computing device 110 proceeds to enable the video analytics system 120 only after receiving a response from the computing device of the requesting agency indicating that the electronic computing device 110 has permission to enable the video analytics system 120 to execute video analytics on videos captured by the cameras 130. Alternatively, if the video analytics is already enabled to execute video analytics on videos captured by all identified cameras 130, then the electronic computing device 110 continues to maintain the video analytics system 120 in an enabled state to execute video analytics on videos captured by the cameras 130 to proactively detect and report incidents.

On the other hand, if the electronic computing device 110 determines that the first average cost incurred in resolving incidents reported by the human source is not higher than the second average cost incurred in resolving incidents reported by the video analytics system 120 by at least the predefined threshold, the electronic computing device 110 further determines whether the video analytics system 120 is currently enabled to execute video analytics on videos captured by the cameras 130 (e.g., an identified set of cameras deployed in locations where the incidents included in the first and second set of incidents were reported to have occurred). If the video analytics system 120 is currently enabled to execute video analytics on videos captured by the cameras 130, then the electronic computing device 110 disables the video analytics system 120 from executing video analytics on videos captured by the cameras 130. In one embodiment, the electronic computing device 110 transmits a notification to a computing device of a requesting agency (i.e., an agency requesting the electronic computing device 110 to selectively enable or disable execution of video analytics for an identified set of cameras) with a recommendation that the video analytics be disabled for videos captured from an identified set of cameras 130. The notification may also include information relating to incidents that have been sampled from the incident database 140 for determining that an average cost incurred in resolving incidents first reported by the human source is not higher than an average cost incurred in resolving incidents first reported by the video analytics system 120 by at least the predefined threshold. In this embodiment, the electronic computing device 110 proceeds to disable the video analytics system 120 only after receiving a response from the computing device of the requesting agency indicating that the electronic computing device 110 has permission to disable the video analytics system 120 from executing video analytics on video captured by the cameras 130. Alternatively, if the video analytics is already disabled from executing video analytics on videos captured by all identified cameras 130, then the electronic computing device 110 continues to maintain the video analytics system 120 in a disabled state so that the video analytics system 120 is disabled from executing video analytics on videos captured by the cameras 130.

In accordance with some embodiments, when the video analytics system 120 is enabled to execute video analytics on videos captured by an identified set of cameras 130, the video analytics system 120 proactively (i.e., without relying on a human source to detect and report incidents) analyzes videos captured by the cameras 130 using a video analytics engine to detect an occurrence of a new incident. When a new incident is detected by the video analytics system 120, the video analytics system 120 transmits a report indicating an occurrence of the new incident to the electronic computing device 110 or to another computing device associated with an agency responsible for responding to a particular type of the new incident. In any case, when the new incident is reported, a new electronic record is created in the incident database 140 and the new electronic record is further updated with information relating to the new incident. In addition, the first reporting source field 250 of the new electronic record is updated with an indication that the new incident was reported by the video analytics system 120. When the incident is subsequently resolved by the agency, the incident resolution cost field 260 of the new electronic record is updated to include information relating to a cost or factors contributing to the cost of resolving the new incident. In accordance with some embodiments, the electronic computing device 110 may continue to monitor the cost incurred in resolving incidents reported by the video analytics system 120 as new incidents first reported by the video analytic system are updated in the incident database 140. For example, the electronic computing device 110 updates the second average cost incurred in resolving the second set of incidents based on the cost incurred in resolving the new incident reported by the video analytics system 120. Optionally, the electronic computing device 110 further determines whether the first average cost incurred in resolving the incidents reported by the human source is higher than the updated second average cost (i.e., updated using the cost incurred in resolving the new incident reported by the video analytics system 120) by at least the predefined threshold. When the first average cost is higher than the updated second average cost by at least the predefined threshold, the electronic computing device 110 continues to maintain the video analytics system 120 in an enabled state to continue to execute video analytics on videos captured by the cameras 130 to proactively detect and report incidents. On the other hand, when the first average cost is not higher than the updated second average cost by at least the predefined threshold, the electronic computing device 110 disables the video analytics system 120 from executing video analytics on videos captured by the cameras 130.

To illustrate the process 400 shown in FIG. 4, consider a hit and run incident that was first reported by a witness via an emergency call service (e.g., 911 call). During the call, the witness shared the incident location and color of the vehicle involved in the incident. Assume the call time was three (3) minutes and within the next one (1) minute, a video search was conducted manually by an officer and a license plate number of the vehicle involved in the hit and run incident was identified based on the information provided by the witness. The dispatcher then sent information identifying the license plate number to first responders located, for example, within five (5) miles (considering the potential driving distance of vehicle during the four (4) minutes) of the incident location and a suspect driving the vehicle was then apprehended. Further assume the cost for resolving the hit and run incident first reported by the witness was estimated at $200 considering the cost associated with handling the emergency call and the cost associated with searching video and apprehending the suspect. Further, assume that the average cost of resolving similar hit and run accidents reported by proactive video analytics is $50. In this case, an agency responsible for responding to hit and run incidents can potentially save $150 (i.e., $200 minus $50) costs by enabling the video analytics system 120 to proactively perform video analytics and report such incidents. Suppose the cost of running proactive video analytics for hit and run accidents in similar regions is $20/month and an average of two (2) incidents per month is reported, then the average cost per incident is $10. In this scenario, the agency has significant cost savings by enabling proactive execution of video analytics on videos captured by cameras 130 deployed in the region.

As another example, consider a hit and run incident that was first reported by a video analytics system 120 along with information regarding the incident location and the license plate number of the vehicle involved in the incident as well the particular video stream in which the incident was captured. The dispatcher dispatched a first responder to the incident location after verifying that the report by the video analytics system 120 was not a false positive. The suspect was then apprehended by the first responder. The cost of resolving the hit and run incident reported by the video analytics system 120 was estimated at $20 considering the human resource cost for validating whether the incident reported by the video analytics system 120 was false positive and apprehending the suspect. Further assume that the average cost of resolving similar incidents reported by the human source to a call taker is $140. In this case, an agency responsible for responding to hit and run incidents can potentially save $120 (i.e., $140 minus $20) costs by enabling the video analytics system 120 to proactively perform video analytics and report such incidents. Suppose the cost of running proactive video analytics for hit and run accidents in similar regions is $40/month and an average of one (1) incident per month is reported, then the average cost per incident is $40. In this scenario, the agency has significant cost savings by not stopping proactive execution of video analytics on videos captured by cameras 130 deployed in the region.

While embodiments of the present disclosure are described with examples relating to assignment of public-safety related video analytics tasks, embodiments of the present disclosure can be also readily adapted for non-public safety use cases such as manufacturing, retail, and healthcare environments where there may be a need to save costs by selectively enabling or disabling execution of video analytics.

As should be apparent from this detailed description, the operations and functions of the computing devices described herein are sufficiently complex as to require their implementation on a computer system, and cannot be performed, as a practical matter, in the human mind. Electronic computing device 110s such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising, ” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of selectively enabling execution of video analytics on videos captured by cameras, the method comprising:
accessing, at an electronic computing device, an incident database identifying incidents resolved by one or more agencies, the incidents including a first set of incidents that were first reported to the one or more agencies by a human source and a second set of incidents that were first reported to the one or more agencies by a video analytics system that is configured to execute video analytics on videos captured by one or more cameras;
estimating, at the electronic computing device, a first average cost incurred in resolving the first set of incidents;
estimating, at the electronic computing device, a second average cost incurred in resolving the second set of incidents;
determining, at the electronic computing device, whether the first average cost is higher than the second average cost by at least a predefined threshold; and
determining, at the electronic computing device, that the video analytics system is currently disabled from executing video analytics on videos captured by the one or more cameras and responsively enabling the video analytics system to execute video analytics on videos captured by the one or more cameras to proactively detect and report incidents when the first average cost is higher than the second average cost by at least the predefined threshold.

2. The method of claim 1, wherein when the first average cost is higher than the second average cost by at least the predefined threshold, the method further comprising:
determining that the video analytics system is currently enabled to execute video analytics on videos captured by the one or more cameras and responsively continuing to enable the video analytics system to execute video analytics on videos captured by the one or more cameras to proactively detect and report incidents.

3. The method of claim 1, wherein when the first average cost is not higher than the second average cost by at least the predefined threshold, the method further comprising:
determining that the video analytics system is currently enabled to execute video analytics on videos captured by the one or more cameras and responsively disabling the video analytics system from executing video analytics on videos captured by the one or more cameras.

4. The method of claim 1, wherein when the first average cost is not higher than the second average cost by at least the predefined threshold, the method further comprising:
determining that the video analytics system is currently disabled to execute video analytics on videos captured by the one or more cameras and responsively continuing to disable the video analytics system from executing video analytics on videos captured by the one or more cameras.

5. The method of claim 1, where estimating the first average cost as a function of one or more of:
a human resource cost for time spent in manually searching videos captured from the cameras for each incident in the first set of incidents after the incident has been reported by the human source; and
a cloud and/or edge computing cost associated with executing video analytics at the video analytics system for each incident in the first set of incidents after the incident has been first reported by the human source; and
a human resource cost for time spent in resolving each incident in the first set of incidents reported by the human source.

6. The method of claim 1, further comprising:
deducting average revenues respectively collected in relation with resolving the first and second set of incidents from the first and second average costs prior to determining whether the first average cost is higher than the second average cost by at least a predefined threshold.

7. The method of claim 1, wherein estimating the second average cost as a function of one or more of:
a cloud and/or edge computing cost associated with executing video analytics at the video analytics system for each incident in the second set of incidents prior to the incident being first reported by the video analytics system;
a human resource cost for time spent in validating each incident in the second set of incidents reported by the video analytics system; and
a human resource cost for time spent in resolving each incident in the second set of incidents reported by the video analytics system.

8. The method of claim 1, further comprising:
responsive to enabling the video analytics system, receiving a report indicating an occurrence of a new incident from the video analytics system;
updating the database with information relating to the new incident; and
indicating, in the database, that the new incident was reported by the video analytics system.

9. The method of claim 8, further comprising:
estimating a cost incurred in resolving the new incident reported by the video analytics system;
updating the second average cost incurred in the resolving the second set of incidents including the new incident reported by the video analytics system; and
determining whether the first average cost is higher than the updated second average cost by at least the predefined threshold.

10. The method of claim 9, further comprising:
continuing to enable the video analytics system to execute video analytics on videos captured by the one or more cameras to proactively detect and report incidents when the first average cost is higher than the updated second average cost by at least the predefined threshold.

11. The method of claim 9, further comprising:
disabling the video analytics system from executing video analytics on videos captured by the one or more cameras when the first average cost is not higher than the updated second average cost by at least the predefined threshold.

12. The method of claim 1, further comprising:
adjusting the predefined threshold as a function of one or more of: criticality of the first set of incidents and second set of incidents, date and time of occurrence of the first set of incidents and the second set of incidents, number of incidents in the first set of incidents and the second set of incidents, one or more regions in which the first set of incidents and the second set of incidents occurred.

13. The method of claim 1, wherein accessing further comprises:
retrieving the first set of incidents and the second set of incidents from the database, such that, the first set of incidents and second set of incidents are of the same or similar type.

14. The method of claim 1, wherein accessing further comprises:
retrieving the first set of incidents and the second set of incidents from the database, such that, the first set of incidents and second set of incidents occurred in a jurisdiction controlled by the same agency.

15. The method of claim 1, wherein accessing further comprises:
retrieving the first set of incidents and the second set of incidents from the database, such that, the first set of incidents and second set of incidents were reported to have occurred at the same location and/or during the same timeframe.

16. The method of claim 1, wherein prior to enabling the video analytics system, the method further comprising:
presenting an electronic notification to the one or more agencies with a recommendation that the video analytics system be enabled for executing video analytics on video captured by the one or more cameras; and
receiving a response indicating permission to enable the video analytics system to execute video analytics on videos captured by the one or more cameras.

17. An electronic computing device, comprising:
a communications interface; and
an electronic processor communicatively coupled to the communications interface, the electronic processor configured to:
access, via the communications interface, an incident database identifying incidents resolved by one or more agencies, the incidents including a first set of incidents that were first reported to the one or more agencies by a human source and a second set of incidents that were first reported to the one or more agencies by a video analytics system that is configured to execute video analytics on videos captured by one or more cameras;
estimate a first average cost incurred in resolving the first set of incidents;
estimate a second average cost incurred in resolving the second set of incidents;
determine whether the first average cost is higher than the second average cost by at least a predefined threshold; and
determine that the video analytics system is currently disabled from executing video analytics on videos captured by the one or more cameras and responsively enable the video analytics system to execute video analytics on videos captured by the one or more cameras to proactively detect and report incidents when the first average cost is higher than the second average cost by at least the predefined threshold.

18. The electronic computing device of claim 17, wherein the electronic processor is configured to:
determine that the video analytics system is currently enabled to execute video analytics on videos captured by the one or more cameras and responsively continue to enable the video analytics system to execute video analytics on videos captured by the one or more cameras to proactively detect and report incidents when the first average cost is higher than the second average cost by at least the predefined threshold.

19. The electronic computing device of claim 17, wherein the electronic processor is configured to:
determine that the video analytics system is currently disabled from executing execute video analytics on videos captured by the one or more cameras and responsively continue to disable the video analytics system from executing video analytics on videos captured by the one or more cameras when the first average cost is not higher than the second average cost by at least the predefined threshold.

20. The electronic computing device of claim 17, wherein the first set of incidents and second set of incidents are of the same or similar incident type.
